(19) United States
(12) Patent Application Publication
(10) Pub. No.: US 2026/0323387 A1
(43) Pub. Date: Oct. 15, 2026

(54) SYSTEMS AND METHODS FOR HEADER COMPRESSION IN WIRELESS COMMUNICATION DEVICES

(71) Applicant: Morse Micro Pty. Ltd., Surry Hills NSW (AU)

(72) Inventors: Pradeep Reddy BHUREDDY, Bangalore (IN); Ria Polly THOMAS, Bangalore (IN)

(21) Appl. No.: 19/455,126

(22) Filed: Jan. 21, 2026

(30) Foreign Application Priority Data
Apr. 11, 2025 (AU) 2025901246

(51) Int. Cl. H04W 28/06; H04L 69/22

(52) U.S. Cl. CPC H04W 28/06; H04L 69/22

(57) ABSTRACT

A device wirelessly communicates with one or more peer devices with compressed frames. A header compression method for the device includes determining a traffic metric for each traffic stream over a predetermined time window, computing an average value for each traffic stream, identifying an active traffic stream based on the average values, and transmitting a header compression request frame to the respective one of the peer devices associated with the active traffic stream. Upon receiving a header compression response frame confirming storage of at least one address, the device may transmit compressed frames omitting the stored address. The respective peer device reconstructs the compressed frames using the stored address.

### CROSS REFERENCE TO RELATED APPLICATION

The present application claims priority from Australian provisional patent application number 2025901246 filed on 11 Apr. 2025, the contents of which are incorporated herein by cross-reference.

### FIELD OF THE INVENTION

The present disclosure generally relates to wireless communication devices. Specifically, aspects of the present disclosure are related header compression techniques in wireless communication networks.

### BACKGROUND

Wi-Fi refers to a family of wireless communication protocols based on the IEEE 802.11 standards. IEEE 802.11ah, also known as Wi-Fi HaLow, is a Sub-1 GHz (S1G) Wi-Fi standard designed to support long-range, low-power wireless communications, particularly for Internet of Things (IoT) and sensor network applications. To address the stringent power and airtime constraints of such environments, Wi-Fi HaLow introduces a Protocol Version 1 (PV1) frame format, which enables secure and efficient data exchange with reduced overhead. PV1 frames are designed to minimize transmission airtime by reducing the size of the Medium Access Control (MAC) layer header and by supporting header compression, while still maintaining essential security and management functionality. This reduction in overhead directly lowers power consumption of both the transmitter and receiver, which is an important benefit for battery-powered and sensor-type stations (STAs). Moreover, in regulatory domains with duty-cycle limitations, minimizing transmission airtime improves channel efficiency and allows networks to make better use of the available frequency spectrum.

The basic components of a PV1 frame generally include a MAC header, a variable-length frame body, and a Frame Check Sequence (FCS) for error detection. The MAC header may contain a subset of the fields defined in conventional IEEE 802.11 headers, including Frame Control, Address 1 (A1), Address 2 (A2), and optional fields such as Sequence Control, Address 3 (A3), and Address 4 (A4). A1 represents the destination address while A2 represents the source address. A3 may carry the Basic Service Set Identifier (BSSID) or, in the infrastructure mode, the final destination address. In mesh or relay-based networks, A3 may instead identify an intermediate relay node address or a final recipient address. The BSSID is also the MAC address of the Access Point (AP) the device is communicating with in the infrastructure mode. A4 is used in Wireless Distribution System (WDS) or mesh networks when additional routing or bridging information is required. It enables multi-hop forwarding by specifying an additional source or destination address of the PV1 frame. For example, A4 specifies the additional hop or forwarding path necessary to route the frame through multiple mesh nodes in a mesh network.

To further reduce the header size, Wi-Fi HaLow allows the use of Short IDs (SIDs) in place of full 6-byte MAC addresses. A1 and A2 may therefore be represented either as globally unique 6-byte MAC addresses or as 2-byte SIDs. MAC addresses are fixed and assigned by manufacturers, whereas SIDs are locally assigned and managed by an AP. SIDs are commonly allocated to low-power sensor-type STAs or IoT devices to minimize header overhead and conserve energy. SIDs are unique only within the scope of a single network managed by an AP. For example, a device initially uses its MAC address to associate with an AP. After the association is completed, the AP assigns a SID to the device. Subsequent communications use the SID instead of the full MAC address, thereby reducing header overhead, decreasing airtime usage, and lowering energy consumption. This behavior is particularly advantageous in dense IoT deployments and long-range HaLow networks.

### SUMMARY

The following summary presents technical features relating to one or more aspects of disclosed herein and should not be considered as an extensive overview relating to all contemplated aspects. Accordingly, the following summary has the sole purpose to present certain concepts relating to one or more embodiments relating to header compression disclosed herein in a simplified form to precede the detailed description presented below.

Some embodiments of a header compression method for a wireless communication device operating in a wireless communication network include determining a traffic metric for each traffic stream over a predetermined time window. The wireless communication device communicates with one or more peer devices through multiple traffic streams. The header compression method further includes computing an average value based on the traffic metric for each traffic stream, identifying an active traffic stream based on the computed average values of the traffic streams, transmitting a header compression request frame to the respective one of the peer devices associated with the active traffic stream, receiving a header compression response frame from the respective peer device, and transmitting one or more compressed frames omitting at least one address to the respective peer device. The header compression request frame comprises a header compression element for instructing the respective peer device to store one or more addresses corresponding to the active traffic stream. The header compression response frame sent by the respective peer device confirms storage of one or more addresses. Some examples of the header compression request or response frame include association request, reassociation request, association response, reassociation response, and action frames. In some preferred embodiments, header compression request or response information is either carried in an action frame or in an Information Element (IE) of an association or reassociation request or response frame.

In some embodiments of the header compression method, each of the compressed frames carries one bit indicating an absence of each omitted address. For example, the header compression request frame includes Address 3 (A3) and a store A3 indication, where A3 carries a BSSID, a final destination address, an intermediate relay node address, or a final recipient address, and the store A3 indication is set to instruct the respective peer device to store A3. In another example, the header compression request frame includes Address 3 (A3), Address 4 (A4), a store A3 indication, and a store A4 indication. A4 carries an address specifying an additional hop or forwarding path for additional routing or bridging. The store A3 indication and the store A4 indication are set to instruct the respective peer device to store both A3 and A4.

The average value for each traffic stream is computed using a moving window average procedure across multiple time windows in accordance with some preferred embodiments of the present invention. Each of the traffic streams carries 3-address frames or 4-address frames and computing an average value may further include applying a scaling factor to the average value depending on whether the traffic stream carries 3-address or 4-address frames. For example, the average value is scaled up if the corresponding traffic stream carries 4-address frames. Some embodiments of the average value are computed based on a weighted combination of the determined traffic metric and a historical average.

In some embodiments, the traffic metric for each traffic stream includes a number of packets or frames transmitted with respect to the traffic stream within the predetermined time window. In some other embodiments, the traffic metric for each traffic stream includes both a number of transmitted packets or frames and a number of received packets or frames within the predetermined time window. In one embodiment, the wireless communication device identifies the active traffic stream, stores at least one address corresponding to the active traffic stream by transmitting an action frame to instruct the respective peer device to store one or more addresses, thereby the wireless communication device can send compressed data frames to respective peer device omitting the stored one or more addresses.

An embodiment of the header compression method further comprises receiving an unsolicited header compression response frame from the respective peer device which has no address stored, initiates transmitting the header compression request frame to instruct the respective peer device storing at least one address corresponding to the active traffic stream. In some embodiments, the wireless communication device retransmits the header compression request frame upon expiration of a predetermined timeout without receiving the header compression response frame from the respective peer device.

The respective peer device reconstructs the compressed frame with at least one omitted address using the previously stored address. In some embodiments, the wireless communication device continuously monitors the traffic metric for each traffic stream and issues a new header compression request frame when a new active traffic stream is identified.

One aspect of the present invention is a wireless communication device operating in a wireless communication network, including a transceiver configured to transmit and receive wireless frames, a processor, and a memory communicatively coupled to the processor and storing processor readable codes. The wireless communication device is configured to determine a traffic metric for each of traffic streams communicated between the wireless communication device and one or more peer devices over a predetermined time window, compute an average value based on the traffic metric for each traffic stream, and identify an active traffic stream based on the computed average values. The wireless communication device transmits a header compression request frame to the respective one of the peer devices associated with the active traffic stream, receives a header compression response frame from the respective peer device confirming storage of at least one address, and transmits one or more compressed frames omitting the at least one address to the respective peer device.

Other objects and advantages associated with the aspects disclosed herein will be apparent to those skilled in art based on the accompanying drawings and detailed description.

### BRIEF DESCRIPTION OF THE DRAWINGS

Illustrative aspects of the present application are described in detail below with reference to the following drawing figures:

FIG. 1A illustrates a Header Compression element format defined in the IEEE 802.11ah standard.

FIG. 1B illustrates subfields of a Header Compression control field in the Header Compression element.

FIG. 2 illustrates an example of direct traffic sent using PV1 2-address frames between an AP and a STA.

FIG. 3 illustrates an example of traffic flows sent using PV1 3-address frames between a STA and an AP connected to a gateway device.

FIG. 4 illustrates an example of traffic flows sent using PV1 4-address frames between an AP connected to a gateway source and a STA connected to a destination device.

FIG. 5 is a table for recording traffic streams for a device and tracking the active traffic stream according to an embodiment of the present invention.

FIG. 6 is a flowchart illustrating a method of header compression in accordance with an embodiment of the present invention.

FIG. 7 is a simplified block diagram of a wireless communication device implementing an embodiment of the present invention.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth to provide a thorough understanding of aspects of the application. However, it will be apparent that various embodiments may be practiced without these specific details. The following description of the embodiments will provide those skilled in the art with an enabling description for implementing an example aspect. Changes may be made in the function and arrangement of elements without departing from the spirit and scope of the application as set forth in the claims.

A draft version of the IEEE 802.11 wireless networking standard, IEEE P802.11-REVme/D4.0, defines various frame formats and procedures supporting Enhanced Throughput (EHT) data transmission in Wireless Local Area Networks (WLANs). These data frame formats are structured to enable effective communication between devices in a wireless network. It specifies the use of different address types, including support for 2-address, 3-address, and 4-address data frames, which are selected depending on the nature of the traffic, such as unicast, multicast, or broadcast. The draft also defines a header compression procedure that enables S1G STAs to reduce MAC-layer overhead by storing certain address fields and updating security parameters, including a Base Packet Number (BPN), at the receiving side. An S1G STA may include a Header Compression element in Association Request, Reassociation Request, Association Response, and Reassociation Response frames when management frame protection is not negotiated for the association. The Header Compression element may also be included in action frames when a station wishes to initiate or modify header compression settings dynamically. In general, a transmitting STA uses the Header Compression element to indicate to its peer which header fields are subject to compression and therefore must be stored for later reconstruction of compressed frames.

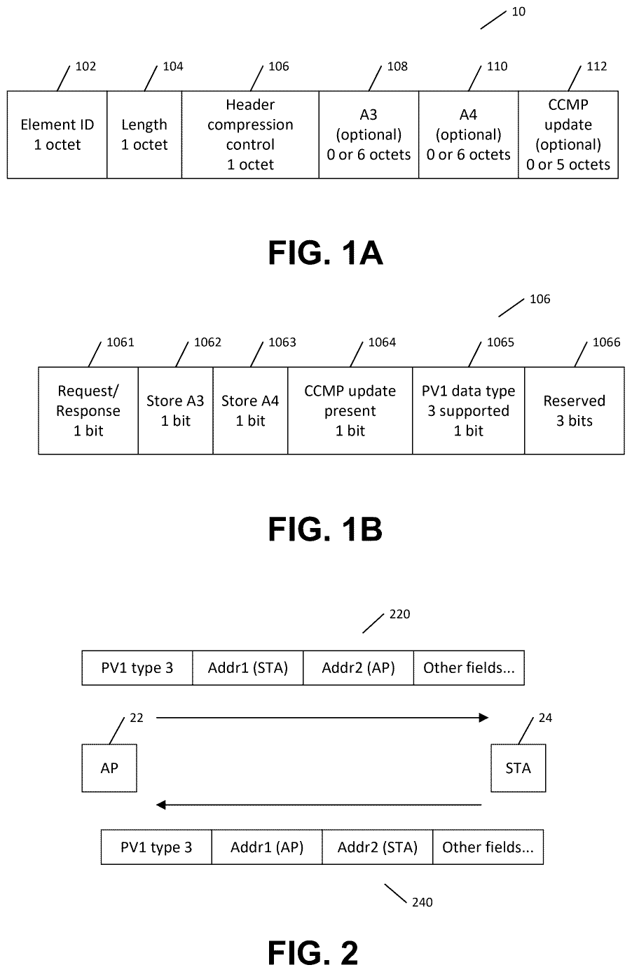

FIG. 1A illustrates an example Header Compression element format for IEEE 802.11ah. Fields in Header Compression element 10 include 1 octet of Element ID 102, 1 octet of length 104, one octet of Header Compression control 106, and some optional fields include 6 octets of A3 108, 6 octets of A4 110, and 5 octets of Counter mode with Cipher Block chaining MAC Protocol (CCMP) update 112. CCMP is the encryption and integrity-protection protocol used in Wi-Fi. The CCMP update field 112 may contain BPN, Key ID, and either a Traffic Identifier (TID) or an Access Category Index (ACI) for which the update happens. The TID is used to identify and prioritize traffic types associated with data frames, whereas the ACI is used to classify and prioritize Quality of Service Management Frames (QMFs). FIG. 1B illustrates subfields of the 1 octet (i.e. 8 bits) Header Compression control field 106. The first bit 1061 of this Header Compression control field 106 indicates whether the frame carrying the Header Compression element 10 is a request frame or a response frame. In a request frame, the one-bit “Store A3” indication 1062 is set to one when the 6-octets A3 MAC address 108 is included in the Header Compression element 10 and the receiving STA is instructed to store A3. In a response frame, the same store A3 indication 1062 is set to one to confirm that the receiving STA has stored A3. Similar behavior applies to the one-bit “Store A4” indication 1063 for the 6-octets A4 MAC address 110. The store A4 indication 1063 is set to one in a request frame when A4 is carried in the Header Compression element 10 and the receiving STA is instructed to store A4. The store A4 indication 1063 is set to one in a response frame to indicate the receiving STA has stored A4. The station therefore requests storage of A3 and A4 by transmitting a request frame in which the applicable indication 1062 and 1063 are set to one. Upon receipt of such a request, the peer station transmits a response frame indicating which of the MAC addresses 108 and 110 have been stored by setting the corresponding indications 1062 and 1063. The Header Compression control field 106 further includes a CCMP update present subfield 1064, a PV1 data type 3 supported subfield 1065, and 3 bits of reserved subfield 1066.

A comparable approach is employed for updating security parameters. An S1G STA may send a request frame with the CCMP update present indication 1064 set to one, indicating there is a CCMP update 112 in the Header Compression element 10, and prompting the receiving STA to acknowledge the CCMP update 112 in a response frame by setting the CCMP update present indication 1064 to one. Upon receiving the new BPN value, the receiving STA compares it to its currently stored BPN and updates the stored value if the received BPN is greater. To initiate any header compression procedure, an S1G STA transmits a Header Compression request frame asking the recipient to store one or more fields. The S1G STA postpones transmission of PV1 data frames that omit those fields until a confirming response frame is received. For example, the S1G STA transmits a Header Compression request frame asking a receiving STA to store the 6 octets A3 and security information BPN. If a response frame is not received by the S1G STA within a predetermined timeout period, the S1G STA may retransmit the request action frame. The receiving STA stores and activates the included fields before transmitting a corresponding response frame. In this example, the receiving STA stores the 6 octets A3 and BPN and sends a response frame with both the store A3 indication and the CCMP update present indication are set to one in the Header Compression control field of the Header Compression element.

In cases when a station receives a compressed PV1 data frame containing one or more addresses that it has not previously stored, it transmits an unsolicited Header Compression response to the sender with both the “Store A3” indication 1062 and “Store A4” indication 1064 set to zero. The sender receives such an unsolicited Header Compression response transmits a new Header Compression request frame including the one or more addresses that must be stored by the station for future communication. In cases when a station receives a PV1 data frame which triggers a decryption error, it transmits an unsolicited Header Compression response frame including the TID or ACI of the received PV1 data frame in the corresponding subfield of the CCMP update field, where the CCMP update field indicates the stored BPN and Key ID that correspond to the received PV1 data frame. If a station that has previously transmitted PV1 data frames of a given TID or ACI to a peer station and receives such an unsolicited Header Compression response from the peer station, it transmits a new request frame to this peer station, including the security information that must be stored for the indicated traffic flow.

Upon receiving an acknowledgement of address storage from the peer station, a PV1-capable S1G station may omit transmitting an A3 address in the 3-address frame and both A3 and A4 addresses in the 4-address frame to reduce header overhead and thereby reducing transmission airtime. The peer station receives the compressed frames and reconstructs the one or more required address fields using previously stored address(es). Under the current interpretation of the standard, each station can only store one set of address(es) for a traffic stream, either an A3 address or one set of A3 and A4 addresses. When multiple traffic streams exist, the station must therefore identify the active traffic stream among the traffic streams that will benefit the most from storing the corresponding A3 and A4 values. Different types of traffic streams use different PV1 frame types. For example, direct traffic between AP and STA may use PV1 2-address frames, which is also referred to as a PV1 type 3 frame. Each 2-address frame carries only A1 and A2 addresses, where A1 is the destination address and A2 is the source address.

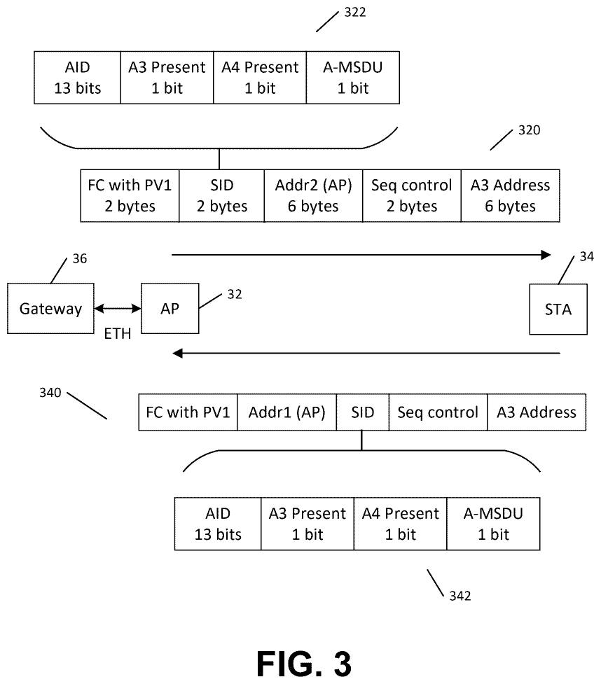

FIG. 2 illustrates an exemplary direct traffic between an AP 22 and a STA 24. The AP 22 transmits a 2-address frame 220 to the STA 24, and then the STA 24 replies with a 2-address frame 240. Traffic between a device connected to a gateway device through an AP's Ethernet (ETH) interface and a station requires 3-address frames and therefore uses PV1 type 0 frames. FIG. 3 illustrates exemplary traffic flows between a STA 34 and an AP 32 connected to a gateway device 36. The AP 32 transmits a PV1 type 0 frame 320 to the STA 34, and the STA 34 transmits another PV1 type 0 frame 340 to the AP 32. This type of traffic needs three MAC addresses as there are three nodes 32, 34, and 36 involved in communications. In these PV1 type 0 frames, a six-byte MAC address can be compressed into a two-byte Short ID (SID), which saves four bytes of header overhead. The SID consists of a 13-bit Association ID (AID) and three flag bits each indicating the presence of A3, the presence of A4, and whether this PV1 type 0 frame contains an Aggregated MAC Service Data Unit (A-MSDU). As shown in FIG. 3, the STA's MAC address is compressed to a SID, so A1 for the destination address is replaced by a 2-byte SID 322 in the PV1 type 0 frame 320. Similarly, A2 for the source address is replaced by a 2-byte SID 342 in the PV1 type 0 frame 340. In some embodiments, the AP 32 can instruct the STA 34 to store the MAC address of the gateway device 36, which is the A3 address carried in the PV1 type 0 frame 320. This header compression can be done by sending the MAC address of the gateway device 36 as A3 in a separate Header Compression request frame from the AP 32 to the STA 34. An example of the Header Compression element in this Header Compression request frame is illustrated in FIG. 1A. The STA 34 receives this request frame from the AP 32 then it stores A3 carried in the request frame. The STA 34 replies a Header Compression response frame to notify this A3 has been successfully stored by the STA 34. The subsequent PV1 type 0 frames 320 sent from the AP 32 to the STA 34 may omit carrying the 6-byte A3 address, further saving the MAC header overhead. In the subsequent PV1 type 0 frames 320, the ‘A3 present’ bit in the SID 322 is cleared to indicate this frame 320 does not carry A3. The STA 34 reconstructs the packet header of the received PV1 type 0 frame 320 using locally stored A3 address. Once the A3 address is stored by the STA 34, the AP 32 takes advantage of header compression to avoid sending the 6-byte A3 address along with a 4-byte difference between the STA full MAC address and the corresponding SID. This results in a total of 10 bytes of header saving in each PV1 type 0 frame 320. Similarly, the STA 34 can send a Header Compression request frame to the AP 32 to request storing the gateway device's MAC address (i.e. A3), the AP 32 can reply with a Header Compression response frame to confirm that A3 is stored. Subsequent PV1 type 0 frames 340 transmitted from the STA 34 to the AP 32 can just carry AP's MAC address as A1 and STA's SID with “A3 present” bit cleared. The AP 32 then reconstructs the full packet according to the stored A3 address.

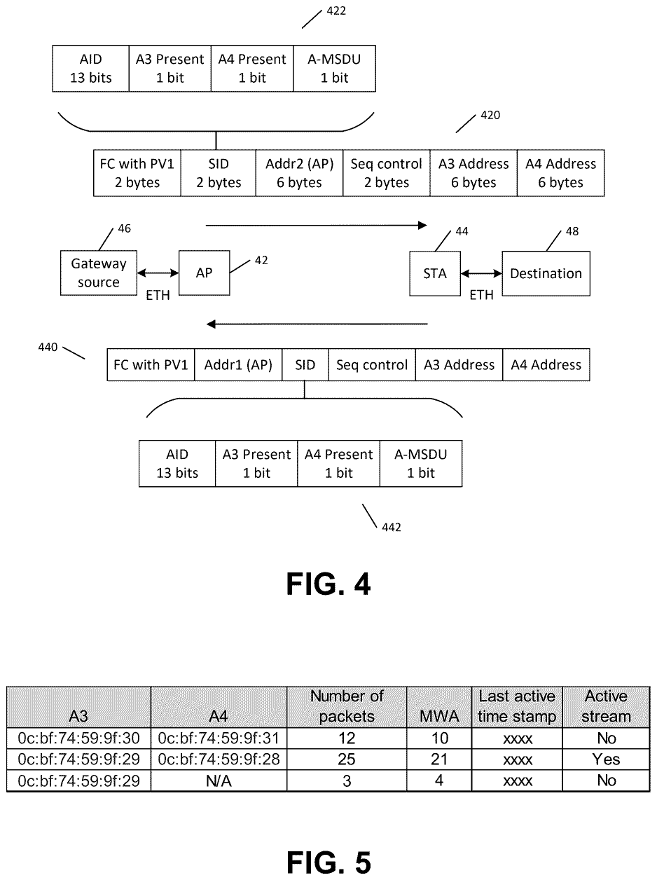

FIG. 4 illustrates exemplary traffic flows between an AP 42 connected to a gateway source device 46 and a STA 44 connected to a destination device 48. The AP 42 connected to the gateway source device 46 through an AP's ETH interface and the STA 44 connected to the destination device 48 through an STA's ETH interface. Each frame communicated between the AP 42 and STA 44 in this wireless network requires four addresses as there are four nodes 42, 44, 46, and 48 involved in this traffic stream. The PV1 type 0 frames can be used as the 4-address frames for this type of traffic stream. As shown in FIG. 4, the PV1 type 0 frames 420 and 440 compress the STA's MAC address from 6 bytes to 2 bytes of SID. The 2-byte SID 422 or 442 is made of 13-bit AID and other bits as shown in FIG. 4. These PV1 type 0 frames 420 and 440 may omit both A3 and A4 addresses by implementing the header compression technique in accordance with an embodiment of the present invention. For example, the AP 42 sends the MAC address of the gateway source device 46 and the MAC address of the destination device 48 in A3 and A4 in a separate single Header Compression action frame, to instruct the STA 44 to store A3 and A4. The STA 44 stores A3 and A4 and replies with a response action frame to the AP 42. Once the 6-byte A3 address and 6-byte A4 address are stored by the STA 44, along with the 4 bytes saving achieved by the 2-byte SID for the STA's MAC address, the PV1 type 0 frame 420 sent by the AP 42 saves up to sixteen bytes of MAC header. The corresponding A3 present bit and A4 present bit in the SID 422 are cleared to 0 when both A3 and A4 are no longer conveyed in the frame 420. The STA 44 uses the stored A3 and A4 to reconstruct the packet header whenever it receives a PV1 frame 420 with A3 present bit and/or A4 present bit in SID 422 cleared. Similarly, when the destination device 48 connected to the STA 44 through the ETH interface needs to send data traffic to the gateway source device 46 on the AP side 42, the STA 44 can send a Header Compression action frame to store both the MAC addresses of the gateway source device and destination device on the AP 42 as A3 and A4. Subsequent PV1 frames 440 can just carry the AP's MAC address and STA's SID 442 with the A3 present bit and A4 present bit cleared. The AP 42 receiving these PV1 frames 440 uses the stored A3 and A4 addresses for reconstruction of full packets.

In some embodiments of the present invention, a wireless communication device stores only a single set of A3 and A4 addresses and therefore employs an active stream selection mechanism to identify an active traffic stream that yields the maximum airtime savings when implementing header compression. Embodiments of the wireless communication device, either an AP or a STA, determine a traffic metric for each traffic stream and dynamically select an active traffic stream based on the record according to the active stream selection mechanism. In some embodiments, the traffic metric of each traffic stream includes a number of transmitted packets or frames within a time window corresponding to the traffic stream. In some other embodiments, a number of transmitted and received packets or frames within a time window between two devices are considered as the traffic metric of each traffic stream. For example, the wireless communication device combines the number of packets transmitted to a peer device and the number of packets received from the peer device. Some embodiments further calculate an average value such as a Moving Window Average (MWA) of the traffic metric for each traffic stream. The wireless communication device may record a timestamp of the last activity observed for each traffic stream. Some embodiments of the wireless communication device maintain a table using a moving window average procedure, which involves recording the traffic metric for each fixed-size time window. FIG. 5 shows an exemplary table recording multiple traffic streams and tracking of the active traffic stream according to an embodiment of the present invention. In this exemplary table, the first two traffic streams are traffic streams conveying 4-address frames while the third traffic stream is a traffic stream conveying 3-address frames. Each of the numbers of packets recorded in this table is counted within a predetermined time window, for example, within a 60 second period. The MWA value of the second traffic stream is the highest among the three traffic streams so the second traffic stream is selected as the active traffic stream in this example. In one embodiment, a sliding one-minute time window may be used. The number of packets that are sent to each traffic stream with specific MAC addresses within a time window are counted, and the count for each traffic stream is averaged over multiple time windows. In one embodiment, each update may compute a new Moving Window Average (MWA) value for each traffic stream based on a weighted combination of the current window's packet count and the historical MWA corresponding to the traffic stream. For example, a weighted ratio of 20% assigned to the current window and 80% assigned to the historical average yields an updated MWA value equal to (2×current value+8×current average)÷10. Other weightings may also be used, for example, a weighted ratio of 50% indicates equal importance to the recent packet count and the history of traffic flow. A periodic timer updates these values and clears the current window counts. In one example, a historical MWA value for a given traffic stream is 100 packets per minute, and a number of packets transmitted in the most recent one-minute window is 150 packets, the updated MWA value for this traffic stream is (2*150+8*100)/10=110 packets per minute. Based on the computed MWA values, the device selects the traffic stream whose A3 address or A3 and A4 addresses should be stored to provide the greatest reduction in transmission overhead.

In some embodiments, the device keeps a table recording multiple traffic streams to track for the active traffic stream, whereas in some other embodiments, the device just maintains an average value for each traffic stream. An independent periodic timer is used for updating the table or for updating the average values and clearing the current value of the packets received for each traffic stream. The device may use a rhastable or any suitable data structure to maintain these records for active traffic stream tracking. The device may consider one or more factors to decide the number of entries in the rhastable for tracking the active traffic stream.

In IEEE 802.11 standards, a frame refers to the Layer-2 transmission unit defined by the MAC protocol, whereas a packet refers to the Layer-3 or high-layer data unit such as an Internet Protocol (IP), Transmission Control Protocol/User Datagram Protocol (TCP/UDP), or application payload. Frames are the entities transmitted over the wireless medium that include MAC headers, control fields, and an encapsulated payload including one or more packets. In a typical S1G operation, a single MAC frame carries one complete higher-layer packet, enabling efficient and low-overhead delivery suitable for low-power IoT environments. In some embodiments of the present invention, instead of counting the number of packets in each traffic stream, the number of frames transmitted in each traffic stream over a time window is counted for identifying the active traffic stream.

In practical deployments, it may be advantageous to prioritize storage of addresses associated with 4-address traffic streams, as these yield greater savings than 3-address traffic streams. For example, storing A3 and A4 for 4-address frames results in sixteen bytes of header overhead savings, whereas storing only A3 for 3-address frames results in ten bytes of header overhead savings. This approximately amounts to 62% more savings. Consequently, some embodiments of active stream determination for header compression apply a scaling factor, such as additional sixty percents, to scale up the average values of 4-address traffic streams or apply a scaling factor to scale down the average values of the 3-address traffic streams. This emphasizes traffic streams carrying 4-address frames relative to those carrying 3-address frames in the active stream determination process.

In some embodiments, a device sends a Header Compression request frame requesting a corresponding peer device to store one or more addresses after determining an active traffic stream. The device postpones the transmission of frames belonging to the active traffic stream until it receives a corresponding Header Compression response frame. Upon receiving the Header Compression response, the peer device stores and activates the included address(es) it intends to store and/or the security information included in the Header Compression request frame, then the peer device transmits the corresponding Header Compression response frame. The device receiving the Header Compression response frame can then transmit frames belonging to the active traffic stream without sending the stored addresses. The device may re-transmit the Header Compression request when it has not received the corresponding Header Compression response frame within a predefined timeout.

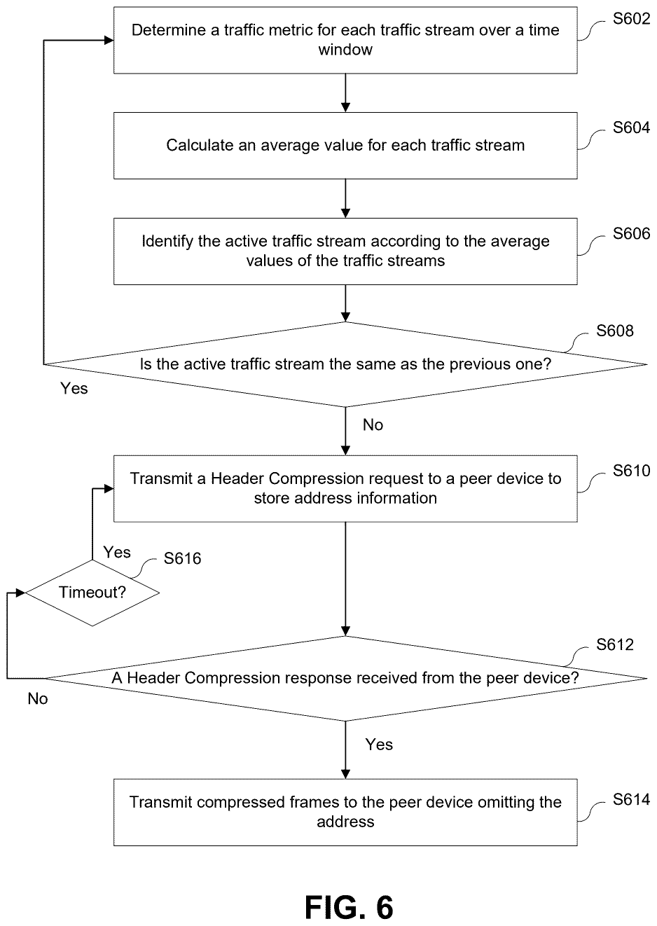

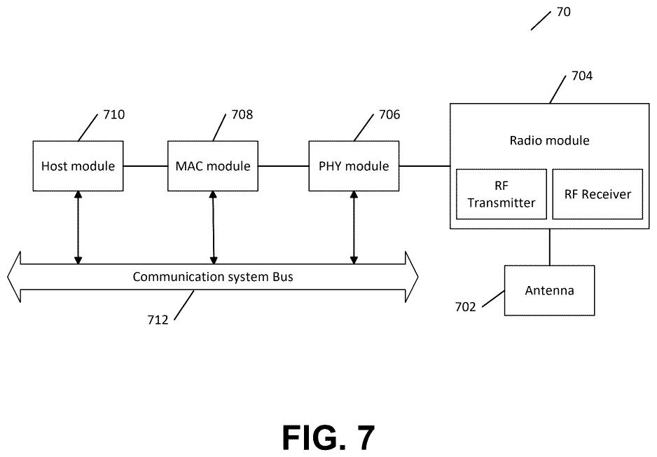

The flowchart in FIG. 6 illustrates a method of header compression according to an embodiment of the present invention. Header compression is applied to frames of a traffic stream communicated between two wireless devices, where either the source or destination, or both, are gateway devices connected to one or both the wireless devices. A traffic stream carries 3-address frames when three nodes are involved, and 4-address frames when four nodes are involved. In this embodiment, a first device transmits one or more packets to one or more wireless devices through multiple traffic streams, each traffic stream containing either 3-address or 4-address frames. The first device or wireless device can be any device configured to transmit or receive IEEE 802.11-compliant frames, including but not limited to an AP, STA, relay device, mesh node, gateway device, IoT end device, or any embedded system incorporating a Wi-Fi transceiver. The first device determines a traffic metric for each traffic stream over a fixed-size time window in step S602, for example, it counts a number of packets transmitted for each traffic stream. In step S604, the first device calculates an average value for each traffic stream based on the determined traffic metric. For example, the average value for each traffic stream is calculated by a moving window averaging procedure that averages packet counts across multiple fixed-size time windows. In another example, the average value for each traffic stream is calculated by weighted averaging a current packet count with one or more historical values. In some embodiments, the calculated average value for each traffic stream is further scaled according to the type of traffic stream. For instance, an average value associated with a traffic stream carrying 4-address frames is scaled upward, or an average value associated with a traffic stream carrying 3-address frames is scaled downward, in order to give preference to storing 4-address frame traffic streams over 3-address frame traffic streams.

The first device identifies an active traffic stream according to the average values of the traffic streams in step S606. For example, the first device selects the traffic stream having the highest average value as the active traffic stream. In step S608, the first device determines whether the newly identified active traffic stream is the same as the previously identified active traffic stream. If they are the same, the first device repeats steps S602 to S606 to update the average values for the traffic streams and identify the active traffic stream based on the updated average values. In the embodiment shown in FIG. 6, the active traffic stream is identified after each fixed-size time window, whereas in other embodiments, the active traffic stream may instead be identified after multiple consecutive time windows. When a new active traffic stream is identified by the first device in step S608, it transmits a Header Compression request frame to a peer device corresponding to the active traffic stream in step S610. For example, the Header Compression request frame sent from the first device instructs the peer device to store A3 address or both A3 and A4 addresses associated with the active traffic stream. The first device then waits for a corresponding Header Compression response frame sent from this peer device in step S612. Upon successfully receiving the response frame before timeout expiry, the first device proceeds to step S614, where it transmits compressed frames omitting A3 address or omitting both A3 and A4 addresses to the peer device. The peer device can reconstruct these compressed frames using the stored A3 address or both A3 and A4 addresses. For example, a PV1 frame may be transmitted in which the A3 present bit, or both the A3 present and A4 present bits in the SID field, are cleared, indicating A3 or both A3 and A4 are not included in this PV1 frame. In step S616, the first device sets a timeout for receiving the Header Compression response frame. If the Header Compression response frame is still not received when the timeout expires, the first device retransmits the Header Compression request frame to the peer device as shown in step S610. In one embodiment, the first device retransmits the Header Compression request frame only once. If a corresponding Header Compression response frame is still not received before the timeout expires, the first device may then select another active traffic stream based on the average values to request address storage. In some embodiments of the present invention, even while the first device is communicating with the peer device using the header compression technique, it continuously records packet counts for each traffic stream and issues a new Header Compression request to another peer device to store corresponding address information whenever a new active traffic stream is subsequently identified.

In the embodiment illustrated in FIG. 6, only the number of packets transmitted for each traffic stream is used as the traffic metric to determine the active traffic stream. In other embodiments, both the numbers of transmitted and received packets are considered. One traffic stream may be defined as including both received and transmitted frames between the same pair of wireless devices connecting to the gateway device(s). In one embodiment, the traffic metric of each traffic stream is simply the sum of the number of transmitted packets and the number of received packets with respect to the same traffic stream within a predetermined time window. These transmitted and received frames are classified into the same traffic stream based on their respective source address and destination addresses. In another embodiment, the traffic metric of each traffic stream is determined by a weighted combination of the number of transmitted and received packets within a predetermined time window. In some embodiments, each traffic stream includes only the transmitted frames containing the same set of addresses, or it only includes the received frames containing the same set of addresses. Each set of addresses includes A1, A2, and A3 for 3-address frames, or it includes A1, A2, A3, and A4 for 4-address frames. In such cases, the active traffic stream may correspond to either a receiving traffic stream or a transmitting traffic stream. Some embodiments of active traffic stream determination apply a weighting factor to prioritize the transmitting traffic stream over the receiving traffic stream, or vice versa, depending on the application.

In some embodiments of the present invention, the wireless communication device notifies its peer device of one or more addresses associated with the active traffic stream that are stored locally, allowing the peer device to transmit compressed frames to the wireless communication device without incorporating these stored addresses. The wireless communication device sends a notification to the peer device through an action frame according to an embodiment. Consequently, the wireless communication device receives compressed frames omitting these addresses from the peer device and it reconstructs the compressed frames based on the stored addresses. In some embodiments, after identifying an active traffic stream, the wireless device transmits a header compression request frame to the respective peer device to request address storage, followed by an action frame notifying the respective peer device that it has also stored the same set of addresses. The respective peer device then stores the set of addresses and replies with a header compression response frame. Thereafter, both devices can exchange compressed frames omitting the stored addresses while maintaining correct frame reconstruction.

An embodiment of a header compression system 70 in a wireless communication device includes an antenna module 702, a radio module 704, a communication system bus 712, a PHY system 706, a MAC module 708, and a HOST module 710. These modules may be implemented in hardware, firmware, software, or a combination, and may be individually or in combination with various types of Integrated Circuit (IC), including one or more of a General Processing Unit (GPU), an Application Specific Integrated Circuit (ASIC), or Reduced Instruction Set Computer-Five (RISC-V). The radio module 704 includes an RF transmitter and an RF receiver, collectively forming an RF transceiver for transmitting and receiving wireless frame through the antenna module 702. The PHY module 706 bridges between the MAC module 708 and the radio front-end module 704 and is responsible for modulation and demodulation. Specifically, the packets are transmitted by modulating one or more carrier wave signals to encoded digital information according to a clock signal. Received packets are demodulated to reconstruct the original digital information according to the clock signal. The Host module 710 is responsible for running high level functionalities of the header compression system 70. The PHY module 706, the MAC module 708, and the HOST module 710 communicate with each other via the communication system bus 712. The antenna module 702 may include a single antenna or multiple antennas. An embodiment of the header compression system 70 determines a traffic metric for each traffic stream during a time window, computes an average value based on the traffic metric for each traffic stream, and identifies an active traffic stream based on the computed average values of the traffic streams. The header compression system transmits a header compression request frame to a respective peer device associated with the identified active traffic stream. The respective peer device stores at least one address upon receiving the header compression request frame and sends out a header compression response frame. The header compression system transmits compressed frames for the active traffic stream without including the stored address in the compressed frame after receiving the header compression response from the respective peer device.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present application.

What is claimed is:

1. A method of header compression for a wireless communication device operating in a wireless communication network, comprising:
determining, over a predetermined time window, a traffic metric for each of a plurality of traffic streams communicated between the wireless communication device and one or more peer devices;
computing, for each of the plurality of traffic streams, an average value based on the traffic metric;
identifying an active traffic stream based on the computed average values of the plurality of traffic streams;
transmitting a header compression request frame to the respective one of the one or more peer devices associated with the active traffic stream, wherein the header compression request frame comprises a header compression element instructing the respective peer device to store at least one address corresponding to the active traffic stream;
receiving a header compression response frame from the respective peer device confirming storage of the at least one address; and
upon receiving the header compression response frame, transmitting one or more compressed frames omitting the at least one address to the respective peer device.

2. The method of claim 1, wherein each of the one or more compressed frames carries one bit indicating an absence of each of the omitted address.

3. The method of claim 1, wherein the header compression request frame carries Address 3 (A3) and a store A3 indication, wherein A3 carries a Basic Service Set Identifier (BSSID), a final destination address, an intermediate relay node address, or a final recipient address, and the store A3 indication is set to instruct the respective peer device to store A3.

4. The method of claim 1, wherein the header compression request frame comprises Address 3 (A3), Address 4 (A4), a store A3 indication, and a store A4 indication, wherein A3 carries a Basic Service Set Identifier (BSSID), a final destination address, an intermediate relay node address, or a final recipient address, and A4 carries an address specifying an additional hop or forwarding path for routing, wherein the store A3 indication and the store A4 indication are set to instruct the respective peer device to store both A3 and A4.

5. The method of claim 1, wherein the average value for each traffic stream is computed using a moving window average procedure across multiple time windows.

6. The method of claim 1, wherein each of the traffic streams carries 3-address frames or 4-address frames, and computing an average value further comprises applying a scaling factor to the average value depending on whether the traffic stream carries 3-address frames or 4-address frames.

7. The method of claim 6, wherein applying a scaling factor comprises scaling up the average value if the corresponding traffic stream carries 4-address frames.

8. The method of claim 1, wherein the traffic metric for each traffic stream comprises a number of packets or frames transmitted with respect to the traffic stream within the predetermined time window.

9. The method of claim 1, wherein the traffic metric for each traffic stream comprises a number of received packets or frames and a number of transmitted packets or frames with respect to the traffic stream within the predetermined time window.

10. The method of claim 9, further comprising storing at least one address corresponding to the active traffic stream, and transmitting a response action frame to notify the respective peer device that at least one address is stored.

11. The method of claim 1, wherein the average value is computed based on a weighted combination of the determined traffic metric and a historical average.

12. The method of claim 1, further comprising receiving an unsolicited header compression response frame from the respective peer device associated with the active traffic stream, and retransmitting the header compression request frame to the respective peer device instructing the respective peer device to store at least one address corresponding to the active traffic stream.

13. The method of claim 1, further comprising retransmitting the header compression request frame upon expiration of a predefined timeout without receiving the header compression response frame from the respective peer device.

14. The method of claim 1, wherein the one or more compressed frames with at least one omitted address are reconstructed by the respective peer device using at least one previously stored address.

15. The method of claim 1, further comprising continuous monitoring of the traffic metric for each of the traffic streams and issues a new header compression request frame when a new active traffic stream is identified.

16. A system in a wireless communication device, comprising:
a transceiver configured to transmit and receive wireless frames;
a processor;
a memory communicatively coupled to the processor and storing processor readable codes that, when executed by the processor, is configured to:
determining, over a predetermined time window, a traffic metric for each of a plurality of traffic streams communicated between the wireless communication device and one or more peer devices;
computing, for each of the plurality of traffic streams, an average value based on the traffic metric;
identifying an active traffic stream based on the computed average values of the plurality of traffic streams;
transmitting a header compression request frame to the respective one of the one or more peer devices associated with the active traffic stream, wherein the header compression request frame comprises a header compression element instructing the respective peer device to store at least one address corresponding to the active traffic stream;
receiving a header compression response frame from the respective peer device confirming storage of the at least one address; and
upon receiving the header compression response frame, transmitting one or more compressed frames omitting the at least one address to the respective peer device.
